(19) United States
(12) Patent Application Publication
(10) Pub. No.: US 2015/0112505 A1
(43) Pub. Date: Apr. 23, 2015

(54) SYSTEM AND METHOD FOR MANAGING FUELING IN A WORKSITE

(71) Applicant: Caterpillar Inc., Peoria, IL (US)

(72) Inventor: Darryl Victor Collins, Jindalee (AU)

(73) Assignee: Caterpillar Inc., Peoria, IL (US)

(21) Appl. No.: 14/057,562

(22) Filed: Oct. 18, 2013

(51) Int. Cl. G07C 5/00

(52) U.S. Cl. CPC G07C 5/00
USPC 701/1

(57) ABSTRACT

A computer-implemented method for determining that a worksite machine requires refuelling is described. The method involves accessing incident message information and known worksite information; processing the incident message and known worksite information to generate state information; processing the state and known worksite information to generate situation information; and processing the situation and known worksite information to determine that the worksite machine has insufficient fuel to complete the tasks currently assigned to the worksite machine.

### TECHNICAL FIELD

The present invention relates to systems and methods for managing a worksite. The invention is particularity suitable for managing a mining worksite, and will be described in relation to that exemplary but non-limiting application.

### BACKGROUND

The management of large worksites presents complex challenges.

For example, mining worksites such as an open cut mines are typically managed with the broad objective of extracting/producing target material as efficiently as possible. This broad objective is pursued by assigning tasks to various machine and human resources to complete. Many of these tasks are undertaken concurrently and there is significant interdependence between tasks. Failure to complete a task within its parameters—be it due to ambitious task/parameter assignment or unforseen circumstances—can have far-reaching effects.

In addition to assigning tasks, management of a worksite such as a mine can also involve reporting (or making reporting information available) to stakeholders on aspects of the worksite such as productivity and tracking against goals that have been set.

To assist in managing a mining worksite a large amount of worksite data is collected from worksite resources. For example, machine resources (such as loading machines, hauling machines, levelling machines etc) are typically fitted with multiple sensors which record and report data on variables concerning the machine itself, other machines in the worksite, and/or the worksite environment.

Problems with the worksite data, however, can and often do exist. Given the worksite data forms a basis for managing the worksite, such problems can adversely impact the various management tasks required—be it monitoring the worksite, assigning tasks, or reporting to stakeholders.

### SUMMARY

Described herein is a computer-implemented method for determining a worksite machine requires refuelling, the method comprising: operating a processing unit to access incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine; operating said processing unit to access known worksite information selected from a group comprising: known machine parameter information with respect to the worksite machine; known assignment information with respect to the worksite machine; known route information with respect to one or more routes to be travelled by the worksite machine; and known production plan information; operating said processing unit to process said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine; operating said processing unit to process said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine; operating said processing unit to process said situation information and said known worksite information to determine that the worksite machine has insufficient fuel to complete the tasks currently assigned to the worksite machine.

Also described herein is a non-transitory computer-readable medium comprising instructions which, when implemented by a computer processing system, cause the computer processing system to: access incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine; access known worksite information selected from a group comprising: known machine parameter information with respect to the worksite machine; known assignment information with respect to the worksite machine; known route information with respect to one or more routes to be travelled by the worksite machine; and known production plan information; process said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine; process said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine; process said situation information and said known worksite information to determine that the worksite machine has insufficient fuel to complete the tasks currently assigned to the worksite machine.

Also described herein is a computer processing system comprising: means for accessing incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine; means for accessing known worksite information selected from a group comprising: known machine parameter information with respect to the worksite machine; known assignment information with respect to the worksite machine; known route information with respect to one or more routes to be travelled by the worksite machine; and known production plan information; means for processing said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine; means for processing said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine; operating said processing unit to process said situation information and said known worksite information to determine that the worksite machine has insufficient fuel to complete the tasks currently assigned to the worksite machine.

As used herein, the term “comprises” (and grammatical variants thereof) is used inclusively and does not exclude the existence of additional features, elements or steps.

### BRIEF DESCRIPTION OF THE DRAWINGS

Various aspects and features of an embodiment of the invention will be described with reference to the following figures which are provided for the purposes of illustration and by way of non-limiting example only.

FIG. 1 is a pictorial illustration of an example worksite and control centre;

FIG. 2 is a block diagram of the worksite and control centre of FIG. 1;

FIG. 3 is a flow diagram illustrating data processing stages in accordance with an embodiment of the invention; and

FIG. 4 depicts information involved in one example of the processing stages depicted in FIG. 3.

Where possible, the same reference numbers are used throughout the drawings to indicate the same or similar features.

### DETAILED DESCRIPTION

### Worksite Environment

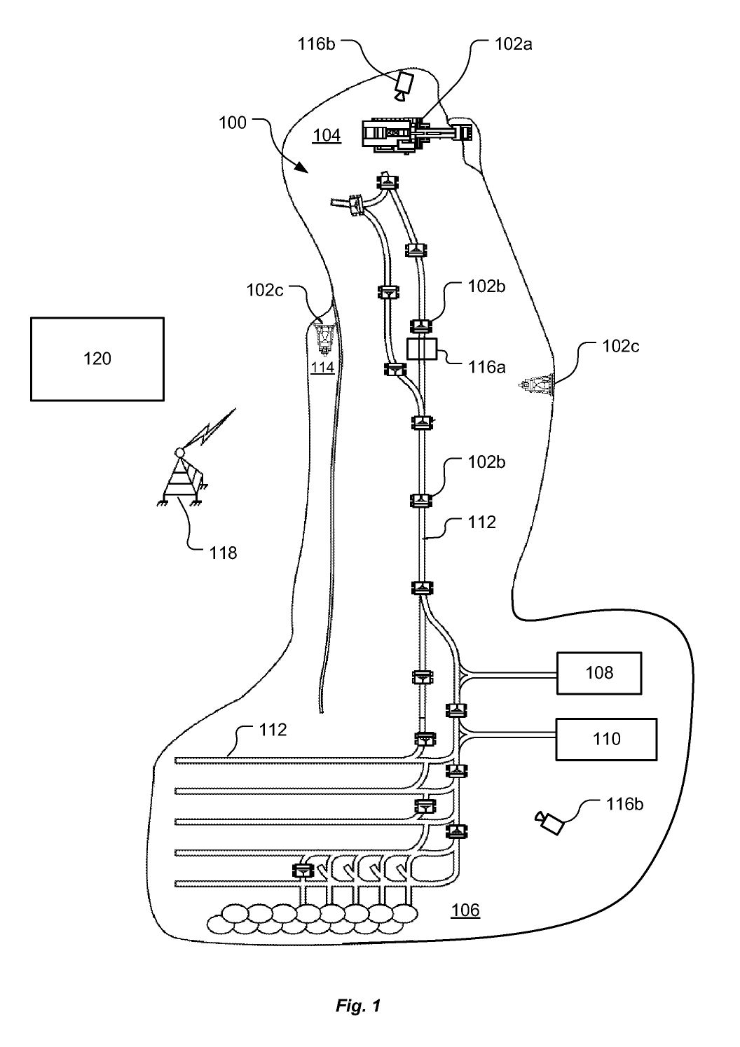

FIG. 1 illustrates a worksite 100 which, in the present example, is a mine worksite.

A number of machines 102 work on or at worksite 100. In this instance the machines 102 depicted comprise a loading machine 102a, haulage machines 102b, and levelling machines 102c (e.g. dozing or grading machines). Machines 102 operating at the worksite 100 may be directly controlled by human operators, remotely controlled by human operators, be autonomous machines capable of autonomously working and traversing the worksite 100, or be semi-autonomous machines configured to perform some functions autonomously and other functions under the control of an operator.

Worksite 100 also comprises a number of locations designated for particular purposes. In this example the locations comprise: a loading location 104 is designated as a location at which a loading machine 102a or other resource operates to fill haulage machines 102b with material; a dump location 106 designated as a location at which haulage machines 102b discard collected material; a refuelling location 108 designated as a location which mobile machines can attend to be refuelled; and a maintenance location 110 designated as a location which mobile machines can attend to be maintained. Worksite 100 also comprises designated roads or paths 112 (which may have multiple lanes) linking various worksite locations and along which mobile worksite machines can travel.

Over the course of worksite operations, machines 102 are assigned with a variety of tasks at the worksite 100. Such tasks comprise tasks directed at altering the geography of the worksite 100 and/or recovering material from the worksite. For example: loading machine 102a may be assigned the task of loading haulage machines 102b with material at loading location 104; haulage machines 102b may be assigned with the tasks of attending loading location 104, receiving a load of material from the loading machine 102a, attending the dump location 106, dumping the material received from the loading machine 102a, and repeating; levelling machines 102c may be assigned the task of clearing or levelling either the loading location 104, the dump location 106, a designated road or path 112, or a development location 114 of the worksite 100.

Worksite 100 may also comprise various dedicated monitoring systems 116 which perform worksite monitoring. For example, worksite 100 is depicted with a weigh bridge 116a (which weighs machines 102 as they traverse the bridge 116a) and a dedicated worksite camera 116b which captures visual data (still or video) of an area of the worksite 100.

Worksite 100 also comprises a radio communications tower 118 operated to relay messages between various worksite machines 102, monitoring systems 116, and a control centre 120. Control centre is shown in this in this instance as being remote from the worksite 100, however could equally be situated on the worksite 100. A given worksite 100 may well have a number of radio communications towers 118 to increase communications coverage and reliability over the worksite 100.

It will be appreciated that the types of machines 102, monitoring equipment 116, designated locations 104, 106, 114 and tasks described above are by way of illustration only. A given worksite may well have additional (or fewer) machines 102 and/or monitoring equipment 116, different types of machines 102 and/or monitoring equipment 116, different designated locations, and/or different task assignments.

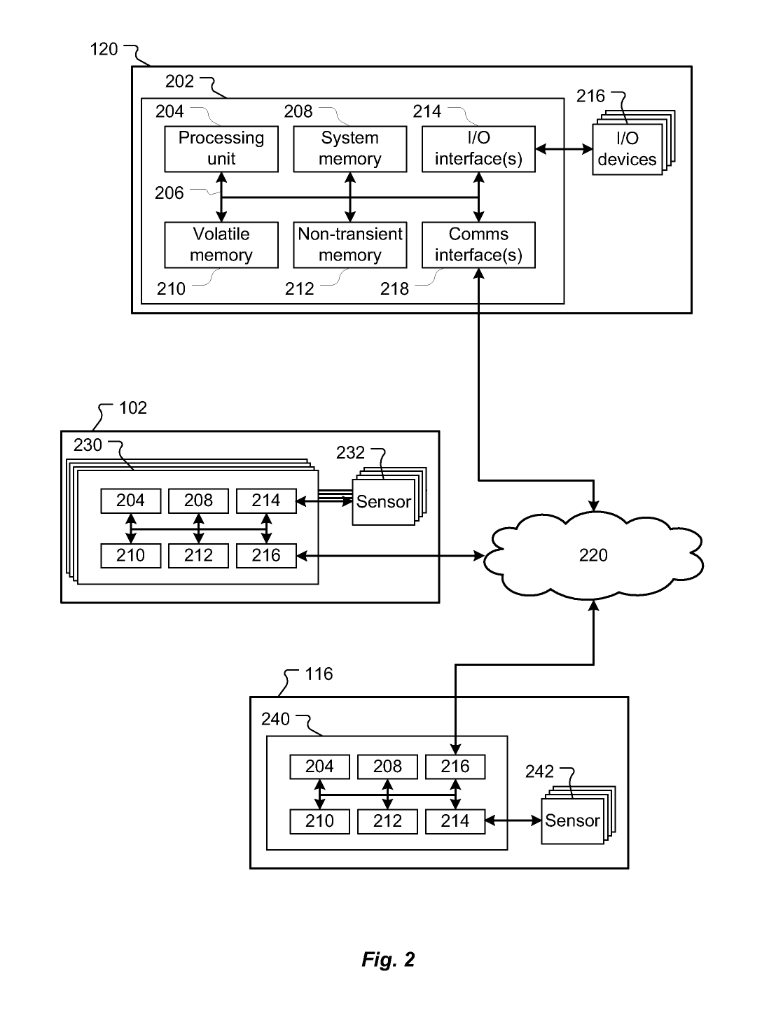

Turning to FIG. 2, a block diagram depicting the worksite 100 and control centre 120 is provided.

Generally speaking, the control centre 120 performs a central monitoring and control function for the worksite 100. This function is achieved by receiving information in respect of the worksite, processing it, and assigning tasks accordingly. To enable this control centre 120 is provided with a computer processing system 202.

Computer processing system 202 (in the present example) comprises at least one processing unit 204 which may be a single computational processing device (e.g. a microprocessor or other computational device) or a plurality of computational processing devices. Through a communications bus 206 the processing unit 204 is in data communication with a system memory 208 (e.g. a read only memory storing a BIOS for basic system operations), volatile memory 210 (e.g. random access memory such as one or more DRAM modules), and non-transient memory 212 (e.g. one or more hard disk drives, solid state drives, flash memory devices and suchlike). Instructions and data to control operation of the processing unit 204 are stored on the system, volatile, and/or non-transitory memory 208, 210, and 212.

The computer processing system 202 also comprises one or more input/output interfaces 214 which allow the system 202 to interface with a plurality of input/output devices 216. As will be appreciated, a wide variety of input/output devices may be used, for example keyboards, pointing devices, touch-screens, touch-screen displays, displays, microphones, speakers, hard drives, solid state drives, flash memory devices and the like. Computer processing system 202 also comprises one or more communications interfaces 218, such as a Network Interface Cards, allowing for wired or wireless connection to a communications network 220 such as a local or wide area network.

Communication with the communications network 220 (and other devices connected thereto) will typically be by the protocols set out in the layers of the OSI model of computer networking. For example, applications/software programs being executed by the computer processing system 202 may communicate using one or more transport protocols, e.g. the Transmission Control Protocol (TCP, defined in RFC 793) or the User Datagram Protocol (UDP, defined in RFC 768). Alternative communications protocols may, of course, be used.

The computer processing system 202 stores in memory and runs one or more applications allowing operators to operate the device system 202. Such applications will typically comprise at least an operating system such as Microsoft Windows®, Apple OSX, Unix, or Linux.

Each worksite machine 102 is also equipped with at least one, and typically multiple, computer processing system(s) 230. Often, a given machine 102 will be equipped with multiple processing systems for performing multiple tasks. For example, a machine 102 may be equipped with a machine vital information management system (e.g. VIMS system as provided by Caterpillar™), a dedicated payload monitoring system, a dedicated tyre pressure monitoring system, and an operator display/control system. Each of these systems may be interconnected so as to be able to communicate with each other and/or be configured to communicate independently with an external communications network or system (e.g. control centre 120). For ease of reference the various computer processing systems of machines 102 will simply be referred to as machine computer processing system 230, but it will be appreciated from the foregoing that machine processing system 230 may, in fact, be multiple independent or interconnected processing systems. The computer processing system(s) 230 of each machine 102 may be similar in some respects to computer processing system 202 described above, though will typically be a dedicated system tailored specifically for the machine and/or operation in question. Each worksite machine 102 is also equipped with a plurality of sensors 232 which be integral with the various computer processing systems of the machine 102, or be separate components that interface with computer processing system(s) 230 of the machine, for example via input/output interfaces 214. The sensors 232 for a given machine typically comprise a number of different types of sensors (and, at times, multiple sensors of the same type) which are operated to sense and detect information regarding the operation of the machine and, in some cases, the environment proximate to the machine.

By way of non-limiting example, the sensors 232 for a machine 102 may comprise: a Global Positioning System (GPS) device, an Inertial Measurement Unit (IMU), radar, lidar, range sensors, video cameras, a fuel level sensor, a fuel pump sensor, payload load sensors, tyre pressure sensors, temperature sensors, a speed sensor, a gear sensor, tool position and/or orientation sensors (e.g. detecting for a haulage machine 102b whether the tray/bed is up or down, or detecting in a loading machine 102a the orientation/position of the dipper). In addition, machines 102 are typically equipped with more sophisticated sensor/monitoring systems (each of which may, for example, be an independent or interconnected computer processing system as discussed above) for monitoring major machine subsystems such as: machine engine; machine transmission; machine suspension; machine tyres; machine steering; machine exhaust; machine electrical and suchlike.

Typically, the sensors 232 of a given machine are controlled by and communicate sensed data to the computer processing system 230 of the machine. The computer processing system 230 processes the raw sensed data to generate predefined messages for transmission to the control centre 120 either in real-time or batch mode. For example, the computer processing system 230 of a machine 102 may periodically process available positional data (obtained, for example, from the GPS, IRU, and any other positional sensors) and generate a position report message reporting on the machine's position in the worksite 100. These messages are then transmitted to the computer processing system 202 of the control centre 120 (and, optionally, stored on a local memory of the computer processing system 230 of the machine 102). Messages between machines 102 and the control centre 120 are discussed in further detail below.

The computer processing system 230 of each machine 102 also enables the machine 102 to receive messages from the control centre 120 (e.g. via a communications interface 218). These messages can comprise, for example, task assignment messages with instructions which define new tasks (or modifying existing tasks) for the machine 102. Such messages can be displayed or otherwise imparted to an operator of the machine 102 (e.g. via output devices such as displays or and or speakers), or where the new/amended task can be carried out without operator intervention be processed by the computer processing system 230 for automatic implementation by the machine 102.

Each dedicated monitoring system 116 of the worksite 100 will also be equipped with (or be) a computer processing system 240. As with the worksite machines 102, the computer processing system 240 of a given monitoring system 116 will be similar in some respects to computer processing system 202 described above, and has been depicted that way in FIG. 2. Once again, however, the computer processing system 240 of a dedicated monitoring system 116 will normally be specifically tailored for that monitoring system and may comprise alternative components. Each dedicated monitoring system 116 will comprise at least one sensor 242 the type of which will depend on the purpose of the monitoring system 116. For example, a weigh bridge such as 116a may comprise a plurality of load sensors, while a worksite camera such as 116b may comprise an image capture sensor (such as a CCD or COMS sensor).

As with the worksite machines 102 described above, the sensors 242 of a given monitoring system are controlled by and communicate sensed data to the computer processing system 240, which can then communicate the sensed data to the computer processing system 202 of the control centre 120.

It will be appreciated that the foregoing example of the control centre 118 computer processing system 202 (referenced also in the context of machines 102 and monitoring systems 116) is provided by way of non-limiting example only. A wide variety of digital processing systems with different components and/or architectures could be used for either the control centre 120, individual machines 102, and/or individual monitoring systems 116.

In addition, although only one vehicle 102 and one monitoring system 116 are depicted in FIG. 2 the worksite 100 will, of course, have multiple vehicles 102 and monitoring systems 116 which communicate data with the computer processing system 202 of the control centre 120.

### Worksite Messages and Information

As noted above, during operation of the worksite 100 information is collected from a wide variety of sensors. Messages (which will be referred to as incident messages) are accessed by the computer processing system 202 of the control centre 120, for example by the messages being transmitted from the various machines 102 and monitoring systems 116 to the computer processing system 202. To illustrate the number of messages (and amount of data) in a being processed, and recognising that all worksites are, of course, different, a typical open cut mine worksite may cover an area of up to (or over) 100 square kilometres and have 1000 or more machines operating simultaneously. By way of estimate, half of the machines may be “heavy” machines (such as loaders, dozers, graders, haulage trucks, draglines and the like), and half or the machines may be “light” machines (e.g. transportation vehicles and suchlike). Each machine may send approximately 1 to 2 messages per second, which can provide for the generation of up to (or over) 2000 incident messages per second.

At the computer processing system 202 of the control centre 120 incident messages (or, at least, the information of the incident messages) are stored in one or more databases maintained, for example, in non-volatile memory 212. The information from the incident messages is made available for use (e.g. access) by programmatic applications and human operators in order to perform various worksite management functions. Broadly speaking, worksite management functions comprise: monitoring functions, dealing generally with monitoring the state/condition of the worksite terrain and machines 102 operating at the worksite 100; assignment functions dealing with the assignment of tasks to worksite machines 102; reporting functions dealing with reporting information regarding the worksite to relevant third parties (e.g. mine owners or stakeholders); and safety functions, providing real time site awareness information to machine operators.

A number of issues with the data gathered from the worksite can, however, exist. Such issues can arise, for example, from: broken sensors leading to expected incident messages not being received; faulty or miscalibrated sensors leading to incident messages comprising inaccurate information; incident messages becoming corrupted; incident messages being delayed; incident messages being received out of order; incident messages being duplicated.

Further issues can arise where incident messages report seemingly contradictory information. For example, in the worksite 100 multiple machines 102 may report on a shared activity from different perspectives. As one simple example, a loading machine 102b may send an incident message reporting the commencement of a loading operation at a certain time t1, a haulage machine 102b which is (in reality) receiving the material from the loading machine 102a may send an incident message reporting the commencement of the loading operation at an alternative time t2, and a camera monitoring system 116b may send visual data that depicts the loading operation in question commencing at a further alternative time t3.

This, in turn, illustrates a more general issue that can arise with worksite information. Time is often a useful dimension for sorting and analysing data (i.e. the chronological sequence of operations that have occurred/are occurring at the worksite). Given the number of machines 102 and monitoring systems 116 operating at the worksite it is generally the case that the internal clocks of various machines 102 and/or monitoring systems 116 are not synchronised. This can complicate the task of trying to generate an accurate timeline of worksite activity and events.

Still further issues with worksite information can arise where a human operator or programmatic application determines that incident message information is incorrect. In such cases corrections can either be made to the raw incident message data or simply make apply local corrections to the data for their own purposes. In either case this can lead to contradictory results as other operators/applications may make alternative corrections and/or use data that has not been corrected.

### INDUSTRIAL APPLICABILITY

To assist in with the management of the worksite 100, the computer processing system 202 of the control centre 120 is configured to process incident messages and other worksite data as discussed below.

The configuration of computer processing system 202 is achieved by software which comprises instructions which can be executed by the processing unit 204 to implement the relevant features of the method. The software/instructions will typically be stored on a non-transient computer-readable medium, such as non-transient memory 212 or an external data storage device which can interface with the computer processing system 202 via, for example, I/O interface 214. The software/instructions may be provided to computer processing system 202 by means of a data signal in a wired or wireless transmission channel over communications interface 218.

As discussed above, one broad type of data/information processed by system 202 is data reported in incident messages generated by worksite machines 102 and monitoring systems 116 and communicated to the processing system 202.

The general purpose of incident messages is to report data relating to the operation of a machine 102 and/or the worksite 100 to the control centre 120 processing system 202. To achieve this purpose a wide variety of message types, message formats, and communication protocols may be used. In order to provide context to this disclosure example messages and message formats will be described, but it will be appreciated that alternative types of messages and message formats may be equally appropriate.

With respect to message format, a typical incident message may comprise: a message type or header field for identifying the type of message and allowing the message contents to be interpreted appropriately; an identifier field for identifying the source of the message (e.g. a specific machine 102 or monitoring system 116); one or more data fields containing the relevant data of the message (the data fields may differ depending on the message type be interpreted according to the message type/header field); and a time field for storing timing information relevant to the message.

By way of more specific example, incident messages such as the following may be utilised:
Position report messages reporting positional information (e.g. coordinates) of a particular machine.
State change messages reporting the current operational state of a particular machine (e.g., for a haulage machine 102b, travelling empty, queuing, loading, travelling loaded, dumping, and suchlike).
Haulage machine dipper report messages, sent from a haulage machine 102b each time a dipper of material is received. Haulage machine dipper report messages typically comprise a header identifying the type of message, a machine identifier identifying the particular haulage machine in question, the sensed weight of the haulage machine payload, and a timestamp.
Loading machine dipper report messages, sent from a loading machine 102a each time a dipper of material is delivered into a loading machine. Loading machine dipper report messages typically comprise a header identifying the type of message, a loading machine identifier, haulage machine identifier (identifying the haulage machine into which material has been loaded), and a time stamp. In certain cases a loading machine dipper report message may also comprise data indicating the type of material that has been loaded.
Haulage machine payload summary messages, sent from haulage machines after a loading operation has completed and the payload has “settled” (e.g. when the haulage machine is travelling loaded and in second gear). Haulage machine payload summary messages typically comprise a header identifying the type of message, a machine identifier, payload weight, and time stamp.
Loading machine dipper summary messages, being a summary of loading machine dipper report messages sent from the loading machine after the loading machine operator has indicated that a given loading operation has completed.
Haulage machine cycle report messages, sent from haulage machines after a payload of material has been dumped at a dumping (or other) location. Haulage machine cycle messages typically comprise a header identifying the type of message, a machine identifier, cycle time information, cycle payload information, cycle fuel usage information, state summary information (e.g. the number of times in each state), distances travelled information (e.g. the distances travelled in each given state), and suchlike.
Haulage machine fuel messages periodically reporting, for example, the current fuel level of the haulage machine and/or the fuel usage of the haulage machine.

In addition to incident message information, the processing system 202 of the control center 120 also knows (i.e. has stored in memory, has access to, or can calculate) and makes use of additional known worksite information relevant to the worksite 100. This worksite information may, for example, relate to:
Known or estimated operating parameters for a given machine 102. For example, system 202 may know that for a given machine 102 the fuel tank capacity, fuel burn rate, a nominal payload, a nominal payload capacity, machine dimension (length, width, height), a machine turning circle and suchlike.
Acceptable ranges for particular data. For example, for a particular type of loading machine 102a the system 202 may store the acceptable weight range for a dipper, for a haulage machine 102b the nominal payload weight and maximum payload weight, for tyres a maximum tyre temperature and suchlike.
Machine assignments. For example, for any given machine 102 the system 202 will know the machine's current assignment and any future assignments that have been given or are to be given to the machine 102.
Route information on routes generally taken by machines when moving between worksite locations (represented, for example, by lists of waypoints or lanes defined in terms of xyz coordinates).
Production plan information providing, for example, a set of target production goals for a given worksite shift (such as a certain number of tonnes of a particular material type being delivered to a given worksite location and blended with a certain number of tones of an alternative material type).
General worksite and other information. Based on received incident messages and other data (e.g. site surveys), system 202 will also know various worksite parameters. For example, a model of the worksite 100 may be built up and maintained (by system 202 or an alternative system) which comprises positional information re roads/paths 112, loading locations 104, dumping locations 106, refueling locations 108, maintenance locations 110, developing locations 114, and any other relevant worksite locations. The model may also comprise data/information as to the geology of the worksite (e.g. the type of material at a given location), material densities and suchlike.

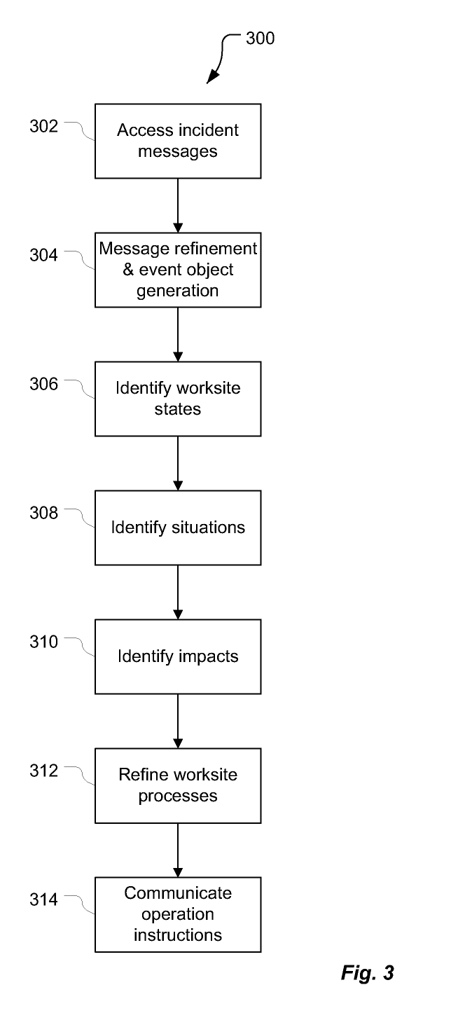

Turning to FIG. 3, a flowchart 300 is provided which illustrates general processing stages system 202 is configured to perform with respect to the available information.

Each of the stages of the process will be discussed in turn in relatively general terms, followed by some more specific examples of how the processing stages can be applied to a mining worksite.

### Incident Message Receipt

At stage 302 incident messages are accessed by the computer processing system 202.

Incident messages may be accessed by being received in real time or batch mode, for example over a communications network 220 or alternative channels. For example, incident messages could be provided on a memory device such as a flash memory or hard disk and accessed by an input/output interface 214 of the computer processing system 202. This may be appropriate in situations where large batches of incident messages are being transferred to processing system 202 or when networked communications are inoperable.

### Message Refinement and Event Object Generation

At stage 304 the processing system 202 generates event objects. Each event object comprises event information defining an event in the worksite 100 and uncertainty data providing a measure of uncertainty in respect of the event information.

Generally speaking, the processing system 202 is configured to generate refined and synthetic event objects.

Each refined event object is based on a corresponding incident message and has event information and uncertainty data based thereon. Refined event objects may have automatically refined event information (i.e. information generated based the data of the corresponding incident message without operator intervention) or operator refined event information (i.e. information generated based on information of a corresponding incident message along with operator input).

Synthetic event objects may also be automatically generated (without direct operator input) or operator generated (based on direct operator input).

These types of event objects and their generation are discussed further below.

### Refined Event Objects

As incident messages are received system 102 processes them to perform basic data checking (and related tasks) to improve the reliability of the data in downstream operations. For each incident message system 202 generates one or more corresponding event objects. In the process of generating an event object system 202 processes the information of the incident message and populates event object data fields with information from, or information derived from, the incident message. In some cases no change to incident message information may be necessary, in which case the incident message information is simply carried over to relevant fields of the event object. In other cases system 202 will identify necessary changes and populate event object fields with information derived from that of the original incident message. Such changes may be automatically identified and made by system 202 (i.e. automatically refined event information) or made taking operator input into account (i.e. operator refined event information). In still further cases system 202 may generate multiple event objects based on a single incident message (for example where an incident message reports multiple pieces of information).

The specific processing performed by the system 202 for a given incident message will depend on the type of incident message in question. At a general level the techniques used may comprise techniques such as threshold or range checking, mapping, and basic modelling. For example, incident message processing may comprise:
Where an incident message type is used to report units of measurement (e.g. distance, weight, elevation, volume, angular displacement and suchlike), processing may involve conversion of the measurement information into standard units used by the system 202.
For example, system 202 may be configured such that all distance calculations and processing is done using meters. For any incident message types that report distances in units other than meters system 202 will process the incident message information to automatically generate a corresponding event object having event information in meters.
This can typically be achieved by simple calculations. For example, where an incident message type reports distances in feet, system 202 processes the incident messages and generates an event object with the distance being the incident distance multiplied by 0.3048).
By way of further examples, different machines (or machine sensor assemblies) may report coordinates in different coordinate spaces (e.g. using WGS84 rather than localised site coordinates) and/or times in different time formats (or from different time zones), in which case system 202 is configured to convert coordinates into localised site coordinates and/or times into a common format/common time zone.
This is one example of generation of an event object with automatically refined event information.
Where an incident message type reports a value about which information is known, processing may involve the system 202 performing range/threshold checking on the reported value to ensure it is reasonable in the circumstances.
For example, the system may know reasonable values for particular message types and check the information from incident messages of those types against the known values on receipt. Where incident message information is reasonable no further action need be taken, however if incident message is not reasonable the message can be flagged for further processing.
By way of specific example, a particular incident message type may report the sensed payload weight of a particular type of haulage machine 102b. For that particular type of haulage machine system 202 may know that the stipulated acceptable operating payload is 200,000 kg. For incident messages of the relevant type, therefore, system 202 compares the reported load against these thresholds. If the reported load is less than 200,000 kg no action need be taken. Alternatively, if the reported load is more than 200,000 kg (or more than 200,000 kg by a given amount) the incident message will be flagged for further processing—for example due to a suspicion that the load sensors for the machine may be faulty. Further processing for a given incident message will, again, depend on the type of message and the reported data. In the above example, system 202 may be configured to raise an operator alert if the reported load exceeds the acceptable operating load. Operator alerts are discussed further below, however generally speaking involve a human operator reviewing a flagged incident message and providing operator input with respect to the event object data that should be comprised in a corresponding event object.
Entity mapping operations. As noted above, incident messages have machine identifiers for identifying the message source. When received by system 202 these machine identifiers are mapped to relevant objects stored/processed by the system as being representative of the machine.
Substituting missing values. If, for example, an incident message is received with one or more missing values, system 202 may be configured to detect this and take corrective steps. For example, if a material type is missing from a loading machine dipper report, system 202 may provide this information (for example with reference to the original assignment information for the loading machine, the material type last reported by the loading machine, or the default material type in respect of the worksite location at which the loading machine is reported to be.
Once again the corrective steps for a missing value will depend on the type of message, and may either be automatically handled by the system 202 or elevated to a human operator by way of an operator alert.
Uncertainty assignment/annotation. System 202 may also be configured to annotate messages with uncertainty information. This may be in accordance with general or specific rules and/or user input.
For example, if a sensor assembly for a given machine has been identified as being faulty, then messages reporting information from that sensor may be annotated as being inaccurate. E.g. if the position sensor of a machine has been identified as being faulty then any positional data reported will be assigned a high level of uncertainty.
Where no specific rules exist, system 202 assigns incident messages with nominal levels of uncertainty/tolerance. This will typically be based on the type of message and data being reported.

Where operator alerts are raised, the system 202 notifies a human operator of the message and the reported exception. Notification may be in any appropriate fashion, for example by displaying an exception on a screen, writing an entry to an exception log, generating and sending an email to one or more email addresses, generating and sending an SMS to one or more phone numbers or suchlike. The incident message is then reviewed by a human operator who determines how to deal with it and whether any additional action is required.

Once an incident message has been elevated to an operator, the operator may determine that the data in question is (in knowledge of broader worksite considerations) acceptable and cause the system 202 to generate an event object with event information corresponding to the data of the incident message (despite the incident message having being flagged for review). Alternatively, the operator may alter the value of the data and cause the system 202 to generate an event object corresponding to the incident message but having information entered by the operator. In light of the operator intervention, each of these cases (i.e. where an operator views but does not change the incident message information and where the operator views and alters the incident message information) is an example of generating event objects with operator refined event information.

The operator may also elect to manually prescribe an uncertainty relating to the data if they are aware (for any reason) that the data is unreliable. In this case the user may, for example, just flag the data as being unreliable in which case system 202 will assign the relevant message/data with an uncertainty level that has been defined as appropriate for data so flagged.

### Synthetic Event Objects

In addition to event objects that correspond to incident messages, synthetic event objects may also be generated which do not have directly corresponding incident messages.

For example, when the system 202 or an operator processes incoming messages (and/or other worksite information) it may be determined that one or more incident messages is missing entirely and create synthetic event objects to account for the apparently missing messages. Although a synthetic event object will not have a directly corresponding incident message, it will still typically be created to mirror a known message type (and having expected data fields corresponding to that message type).

By way of example, if the system 202 or an operator determines that a loading machine dipper message is missing, a synthetic loading machine dipper event to account for the missing dipper message may be generated. Such an event may, for example, be based on data from existing loading machine dipper messages/events (e.g. message type, machine id, material type), however will have a timestamp as estimated by the system 202 or operator.

By way of example, if the system 202 or an operator determines that a loading machine dipper message is missing, a synthetic loading machine dipper event to account for the missing dipper message may be generated. Such an event may, for example, be based on data from existing loading machine dipper messages/events (e.g. message type, machine id, material type), however will have a timestamp as estimated by the system 202 or operator.

Similarly, system 202 may be configured to automatically generate synthetic event objects. This will typically result from further downstream processing of existing event objects and/or operator input. By way of example, an operator may become aware of particular worksite information that is not accounted for by the existing event objects (for example, the position of a machine, the material of a payload, surface elevation information etc). Rather than directly creating a state object (as discussed below) reflecting such information, the operator may provide the state information to the system 202 which, in turn, is configured to automatically generate supporting event objects. For example, an operator may become aware of information that a machine operator has changed and provide operator state information to the system. From this information system 202 may generate an operator logout event object (for the previous machine operator) and an operator login event (for the new operator).

### Data Refinement and State Object Generation

At stage 306 the processing system 202 processes the event objects generated at stage 304 to identify various worksite states.

States provide information on the worksite 100 and can relate to machines 102 or the worksite 100 more generally. By way of example, a particular haulage machine 102b of the worksite 100 may be able to be described by multiple states such as machine payload, machine payload material, machine operator, machine fuel level, machine fuel usage, machine service hours, machine location, machine lane, machine distance along lane, machine distance along route. Alternatively, the worksite 100 may be described by states such as elevations, materials, boundaries, designated locations, planning directives and suchlike.

System 202 is configured to process the event objects (in some instances together with other worksite information) in order to automatically determine or estimate various worksite states. As such, the worksite states are ultimately derived from information provided by incident messages and other worksite information. System 202 then generates state objects in respect of the determined/estimated states. Each state object comprises state information (defining the identified/estimated worksite state) and state uncertainty data (defining an uncertainty with respect to the state information).

System 202 can use a variety of techniques to process the event objects and identify/estimate worksite states. Such techniques can comprise, for example, hypothesis generation techniques, kinematic and attribute estimation techniques, weighted least squares techniques, sequential estimation techniques, alpha/beta filter techniques, covariance error estimation techniques, and filtering techniques, and any other appropriate techniques or methods.

By way of more specific, though again non-limiting, examples, the processing of event objects may comprise:
Feature extraction processing to identify salient features or descriptors from the data which can be used to assist in classifying the underlying data. By way of example this may involve processing incident messages to model data (states) of interest (e.g. payload weights, payload materials, machine operator, machine destination etc).
Classification processing using artificial intelligence/data mining techniques to classify the underlying datastream (e.g. the event objects) as one or more core concepts/states—e.g. loading, dumping, overheating.
Estimation/prediction processing using mathematical modeling techniques to describe relationships between the underlying data (e.g. regression techniques, Kalman filtering techniques and suchlike).
Augmentation by adding additional context information to the underlying event objects. For example, if material information is missing from a load machine dipper summary event this may be augmented with material information generated with reference to the material information of relevant load machine dipper report events.

In addition to identifying worksite states, system 202 determines uncertainty information for each state identified (and, accordingly, uncertainty data for each state object). This allows for rigorous statistical techniques to be used to test relevant hypotheses and, in turn, provide a measurement of certainty in the results of the process. It will be appreciated that a variety of techniques can be used to determine uncertainty information, with the appropriate technique (or techniques) depending on the data in question and other data (if any) available. For example, where a state is in respect of a single measurement uncertainty data may be based on nominal tolerances.

Alternatively, for stationary processes estimates of the standard error of the underlying process can be used as an estimate of uncertainty. In some cases this can be combined with assumptions about a sampling distribution and alpha level (p value) to determine a confidence interval for the measurement/data in question. Still further, for more sophisticated processes, such as regression modeling, confidence intervals can be computed from an associated covariance matrix (which, in turn, is computed as part of the analysis).

### Situation Refinement and Generation of Situation Objects

At stage 308 the processing system 202 processes the state objects generated at stage 306 to identify various worksite situations.

In contrast to the worksite states identified at stage 306, worksite situations provide a more developed view of what is occurring at the worksite 100. By way of example, situations may comprise that: a particular loading machine 102a has loaded a particular haulage machine 102b with a certain weight of material of a certain type; that a haulage machine 102b is en route to a particular worksite location; the remaining fuel of a haulage machine 102b; the TKPH of a haulage machine 102b; that a haulage machine 102b has entered a particular location with a particular amount of material; that data is available for collection from a particular machine 102; that new elevation data has been comprised/fused into a model of the worksite surface.

System 202 identifies various worksite situations based on data from one or more state objects, and generates situation objects accordingly. Each situation object comprises situation information (defining a worksite situation) and situation uncertainty data (defining an uncertainty with respect to the situation information).

System 202 can use a variety of techniques to process the state objects to identify worksite situations (and, accordingly, generate situation objects describing those situations). Such techniques can comprise, for example, feature extraction, parametric template techniques, cluster analysis techniques, adaptive neural network techniques, physical model techniques, knowledge-based methods, hybrid techniques, and any other appropriate techniques or methods.

By way of more specific, though again non-limiting, examples, the processing of state objects may comprise:
Multivariate modeling, for example by multiple or logistic regression.
Extrapolation, for example by using a model to predict behaviors of a system for values of an independent variable outside the range of values on which the model was based. For example, the service hours and/or fuel usage of a machine may be modeled, and those models used to predict the service hours and/or fuel usage of the machine at the end of a current or future shift.
Segmentation of activities to determine the operational state of a machine (e.g. whether a machine was loading, dumping, travelling full, travelling empty) at a particular time.
Spatio-temporal reasoning to infer/predict the locations of particular machines at particular times. For example, given known information where will a machine be in x minutes, or will any machines be at a particular intersection in x minutes.
Bayesian reasoning to determine, given a set of observations, the likelihood of a particular hypotheses being correct. For example, if a loading machine dipper report has been received identifying a particular haulage machine what is the likelihood that the particular haulage machine is/was loading at a particular time.
Dempster Shafer Theory to determine the likelihood of a particular hypothesis being correct in situations where prior probabilities cannot reasonably be estimated.
Summarization of activities to calculate statistical summaries of relevant worksite information/data. For example, the average tones of material moved per machine per shift.

In addition to identifying situations, system 202 uses the uncertainties associated with the state objects to determine an uncertainty for each situation identified (and, accordingly, uncertainty data for each situation object).

Accumulation of uncertainties.

### Impact Estimation

At stage 310 the processing system 202 processes the situation objects generated at stage 308 (if necessary together with other worksite information), to determine the consequences or impacts of the worksite situations that have been identified.

As will be appreciated, a wide variety of impacts may be determined (e.g. by estimation or prediction) depending on the situation objects and worksite information being processed. For example, identified impacts may comprise: that a particular haulage machine 102b will not be able to complete a further loading cycle without first refueling; that a particular haulage machine 102b is suitable for collection of strut data (i.e. to weigh the payload of the machine); that a particular machine 102 will soon have completed all assigned tasks; that an area of the worksite is ready to be operated on; that a model of the worksite can be updated/fused with further information.

System 202 determines impacts based on data from one or more situation objects together with additional data in respect of the worksite 100 (as discussed above). For each determined impact system 202 generates an impact object comprising impact information defining the determined impact together with uncertainty information expressing a confidence as to the correctness of the determined impact.

Once again system 202 may be configured to implement a variety of techniques to process the situation objects (and worksite information) and determine impacts. Such techniques can comprise, for example, decision level identify fusion, classical inference techniques, Bayesian inference techniques, Dempster-Shaefer method based techniques, generalized evidence processing theory based techniques, heuristic methods for identity fusion based techniques, knowledge based techniques, Bayes belief system based techniques.

By way of more specific examples, the processing of situation objects to determine impacts may comprise:
Applying business rules. For example, different customers/worksite stakeholders may have different rules/approaches for summarizing data or deciding between alternative solutions. For example, a particular customer may wish to obtain information as to the average tones of material moved per crew per shift, or set limits on the acceptable roughness of a road/path before grading will be deemed necessary.
Determining consequences of current activity. For example, will a machine run out of fuel, will the tires of a machine overheat, will the power of a machine be degraded such that the overall productivity of the worksite is impacted.

In one embodiment system 202 will implement a rules engine (encoding business rules and rules of thumb) to process situation objects to determine impacts.

The uncertainty information of the upstream situation objects is also processed in order to generate an impact uncertainty, i.e. a level of confidence in the determined impact. The uncertainty information can also be used to test whether two competing hypotheses (impacts) are significantly different.

When certain impacts are identified, particularly those which have been determined to potentially impact worksite safety, system 202 is configured to immediately raise an operator alert in order to alert an operated to the determined impact. Such impacts may be identified according to a rules engine or similar which defines alert criteria against which determined impacts are assessed.

### Process Refinement

At stage 312 system 202 processes the impact objects generated at stage 310 to identify new tasks, or alterations to existing tasks, that could or should be implemented in pursuit of the operational goals of the worksite 100.

Depending on the impacts defined by the impact objects a wide variety of new tasks or task alterations may be identified. For example, based on the impact objects system 202 may identify that: a particular machine 102 should be assigned to a fuelling location on completion of its current cycle; a datalogger of a particular machine 102 should be activated in order to collect data; a new assignment should be generated for a particular machine; surface details for a new area of the mine should be communicated to allow for lanes/roads to be created in the new area.

For each new or amended task that system 202 identifies, system 202 generates one or more operation instructions that can be given to a worksite machine 102, other machine, or human operator in order to perform the task. System 202 may be configured to implement a variety of methods and techniques to generate tasks based on the impact objects, such as optimization techniques (e.g. techniques from Operations Research such as linear programming or from statistics such as regression), auction-based methods (e.g. voting based on decision making techniques), and any other appropriate technique or method.

The uncertainty information from the impact objects is also propagated in order to provide a level of confidence with respect to identified process refinements, and or whether alternative competing process refinements are significantly different. If the uncertainty of an impact object and/or the identified process refinements exceed a given threshold, the impact object and/or instructions reflecting the process refinement may be elevated to an operator for review.

### Communication of Operating Instructions

At stage 314, once tasks have been identified and worksite operation instructions for realising those tasks generated, the operation instructions are communicated to the relevant machine (being either a worksite machine 102 or an alternative machine/processing system) for implementation. This task assignment will typically be automatic, however if under the automated processing defined above a solution addressing an impact is not identified (or a solution with a sufficient confidence level is not identified) it may be elevated to a human operator for intervention.

As with the receipt of incident messages at stage 302, the communication of outgoing instructions may be in real time (e.g. via communications network 220) or in batch mode (either via communications network 220 or an alternative means).

### Operator Interaction

Throughout the various stages of the process system 202 is also configured to present information in respect of the worksite 100 to human operators. This may involve presenting information at system 202 itself (for example by displaying it on one or more displays directly connected to system 202), or communicating the relevant information to independent computer processing systems (e.g. over communications network 220) where it can be presented to an operator for review.

Information may be presented to operators in respect of each of the stages discussed above. For example, system 202 may process incident messages, event objects, state objects, situation objects, worksite impact objects, and operation instructions for display to an operator in a way that clearly imparts the relevant information.

The system 202 is configured to process and communicate information for display in response to an operator requesting certain information (e.g. remotely via communications network 202 or directly via a keyboard or other input device directly connected via the input/output interface 214). For example, an operator may submit a request to system 202 to view current information with respect to a particular machine 102 on the worksite 100. In response system 202 can present the operator with information from, for example, state objects pertaining to the machine 102 in question.

System 202 is also configured to present/communicate certain information to operators automatically. Typically, the automatic presentation/communication of information is based on alert rules which, when triggered, cause the system 202 to elevate information or objects to human operators for review and, if necessary, action. For example, and as touched on above, when processing incident messages and generating event objects at stage 304 the system is configured to alert an operator where incident messages trigger an alert condition (e.g. due to the incident message data exceeding a given threshold or suchlike). Similarly, if in the course of processing system 202 generates information or objects that relate to worksite states, situations, impacts, or operational instructions that have been flagged as requiring operator review/intervention, these will also be brought to an operator's attention.

When system 202 presents/communicates information to an operator it will also allow the operator to easily request and be presented with additional information related to the information in question. For example, if system 202 presents an operator with information from a particular state object, upstream information (e.g. from event objects and incident messages that have contributed to the state object) and downstream information (e.g. from situation objects, impact objects, and operational instructions to which the state object in question contributes) may also be made available.

To facilitate an operator in understanding the various worksite information and objects being processed and generated, system 202 is configured to be able to present information in a variety of ways and using a variety of visualisation techniques. For example, in certain circumstances presenting information in chronological order may make the most sense. While time will often be a useful independent worksite variable against which to visualise information, alternative independent variables will also be appropriate in certain circumstances. By way of example, visualising against alternative independent variables such as worksite location, machine operating hours, machine operator, payload, and any other variable of interest may also be appropriate.

When reviewing information an operator may determine that changes are required. This also has been touched on above with respect to the generation of operator-refined and synthetic event objects at stage 304. For example, an operator viewing incident messages or event objects (either as a result of an alert having being raised or on general review of the information) may decide that data is incorrect or inaccurate and determine a correction is needed. In this case the operator may have direct input into an existing event object or generate an entirely new synthetic event object.

Equally, an operator reviewing downstream information (e.g. relating to worksite states, situations, and/or impacts) may determine that changes to that information are necessary. In this case the operator provides input as to the changes that are necessary (e.g. amended state, situation, or impact information, or a new state, situation, or impact) and system 202 processes the input to determine and generate event objects that support the new/amended states, situations, or impacts.

Once event objects have been refined or generated, these are then processed according to the various stages as discussed above. As will be appreciated this provides for a recursive process which results the information regarding the worksite 100 being dynamic. The refinement of an existing event object or generation of a new synthetic event may well result in system 202 generating alternative state objects, situation objects, impact objects and operation instructions. These alternative states/instructions may, in turn, have lead to still further changes to the worksite information being made and propagating through the various processing stages.

### Examples

In order to further illustrate features of the invention, specific examples of how data may be processed through the various stages discussed above will be provided. It will, however, be appreciated that the method/system described herein can be used to determine (or assist in determining) many other impacts and generate (or assist in generating) many other tasks and instructions based on the worksite information available.

### Refuelling Assignment

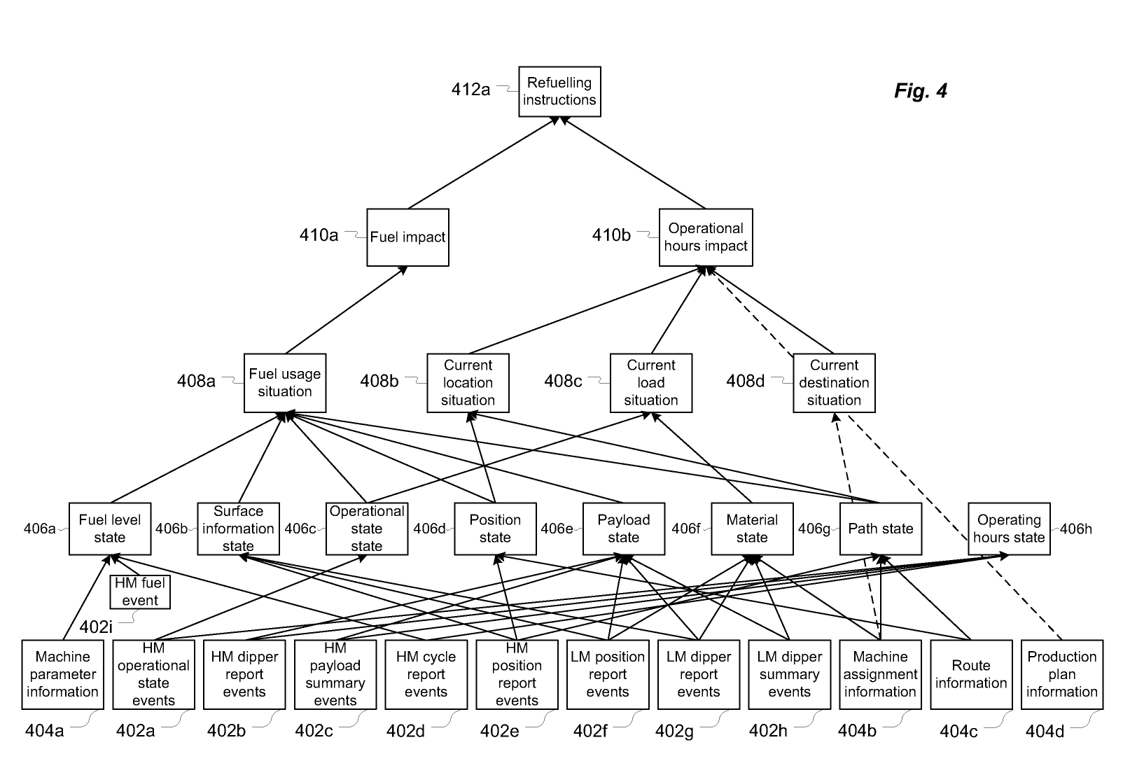

One such example is where processing incident messages and worksite data results in system 202 determining that a particular machine (e.g. a haulage machine 102b) will not be able to complete its currently assigned tasks without refuelling. In this case system 202 can determine that the machine needs to be provided with a refuelling assignment. FIG. 4 depicts the information and processing involved in making this determination.

Amongst the incident messages received by the system 202 (at stage 302) are the following, each of which is processed by system 202 to generate corresponding event objects 402:
haulage machine operational state change messages as discussed above, processed to generate haulage machine operational state event objects 402a;
haulage machine dipper report messages as discussed above, processed to generate haulage machine dipper report event objects 402b;
haulage machine payload summary messages as discussed above, processed to generate haulage machine payload summary event objects 402c;
haulage machine cycle report messages which, as discussed above, provide information such as cycle time information, cycle payload information, cycle fuel usage information, state summary information, and distances travelled information processed to generate haulage machine cycle report event objects 402d;
position report messages as discussed above, processed to generate haulage machine position report event objects 402e and loading machine position report event objects 402f;
loading machine dipper report messages as discussed above, processed to generate loading machine dipper report event objects 402g;
loading machine dipper summary messages as discussed above, processed to generate loading machine dipper summary event objects 402h;
haulage machine fuel messages (reporting, for example, the current fuel level of the haulage machine and/or the fuel usage of the haulage machine), processed to generate haulage machine fuel event objects 402i.

In addition, and as discussed above, system 202 also knows/has access to worksite information 404 which (relevant to the current example) comprises:
machine parameter information 404a, being information in respect of various parameters of different types of machines (e.g. haulage machines 102b) and physical models with respect to the operation of those machines;
machine assignment information 404b, being information as to the current assignments of worksite machines 102;
route information 404c, being information as to the routes taken by worksite machines 102 when moving between worksite locations; and
production plan information 404d, being information as to the broader production plan in respect of the worksite and operational goals.

The system 202 processes the incident messages to generate corresponding event objects (at stage 304).

Based on the event objects and worksite information, system 202 determines and generates a number of state objects 406 (at stage 306) defining a number of worksite states. In this particular example the relevant state objects are as follows:
A fuel level state object 406a in respect of the haulage machine 102b, comprising state information describing the fuel level of the particular haulage machine 102b.
The fuel level state in this instance is based on the haulage machine cycle report events 402d, haulage machine fuel events 402i, and machine parameter information 404a in respect of the haulage machine 102b. This information is processed by the system 202 in order to provide a more accurate an estimate of the fuel level of the haulage machine 102b than would be provided by relying on, for example, a fuel level message alone.
In the present case this is done by use of a Kalman filter process which uses the data available from the incident messages together with the physical model of the fuel usage of the haulage machine 102b.
More specifically, and in one embodiment, the inputs to the Kalman filter may be measured values of fuel level (e.g. from haulage machine fuel event objects), fuel burnt over a given period of time (e.g. derived from the haulage machine fuel messages), and load state (e.g. from haulage machine cycle report event objects). In addition, the Kalman filter may take into account path information. This may be derived from known worksite information alone, or in certain cases may be derived from the path state object 406g discussed below (which provides an example of one state feeding into another state). For the Kalman Filter the path information used may be a calculated effective flat haul distances—i.e. a calculated distance that the path would be if flat. This is calculated by accounting for uphill path sections (which extend the effective length of the path) and downhill sections (which reduce the effective length of the path). For the predictive component of the Kalman filter nominal or modelled fuel burn rates each load state of the machine are used.
A surface information state object 406b in respect of the worksite 100, comprising state information describing the surface of the worksite 100 at which the loading machine 102a is operating.
The surface information state can be based on a variety of sources of information. For example, surface information is derived from loading machine position report events 402f and the loading machine dipper report events 402g, which are processed using regression techniques. Surface information is also based on site survey information provided by haulage machines which, as they traverse roads, provide elevation data in respect of the roads (i.e. as part of their position report messages). In addition (and although not illustrated in FIG. 4), surface state information is derived from levelling machine (e.g. grader) information which resurvey roads when they are graded.
An operational state state object 406c in respect of the haulage machine 102b, comprising state information describing the operational state of the particular haulage machine 102b (e.g. loading, travelling, dumping etc).
In this instance the state information is determined with reference to the haulage machine operational state events 402a.
A position state object 406d in respect of the particular haulage machine 102b, comprising state information describing the position of the haulage machine 102b.
In this instance the state information is determined from the haulage machine position report events 402e along with route information 404c of the machine. This information is processed by the system 202 in order to provide as accurate an estimate of the position of the haulage machine 102b as possible. In the present case this is done by use of a Kalman filter process which uses the data available from the incident messages together with a physical model of the route planned for haulage machine 102b.
A payload state object 406e providing state information as to the payload of the particular haulage machine 102b.
In this instance the state information for the payload state 406e is determined with reference to the haulage machine dipper report events 402b, the haulage machine payload summary report events 402c, the loading machine dipper report events 402g, and the loading machine dipper summary events 402h. This information is processed using filtering techniques to estimate a haulage machine payload weight.
A material state object 406f in respect of the particular haulage machine 102b.
In this instance the material state object 406f is determined with reference to loading machine location events 402e, loading machine dipper report events 402f, loading machine dipper summary events, and machine assignment information 404b. This information is processed to provide as accurate an estimation as possible as to the type of material being carried by the haulage machine 102b. A modelling process may be used to determine a value representing the material type and a confidence level of that determination. For example, the value representing the type of material may be the mode of the inputs and the confidence level may be derived from the proportion of input values that are equal to the mode.
A path state object 406g in respect of the particular haulage machine 102b.
In this instance the state information is determined with reference to the haulage machine position report events 402e along with machine assignment information 404b in respect of the particular haulage machine 102b and route information 404c (being worksite information known to the system 202).
An operating hours state object 406h in respect of the particular haulage machine 102b.
In this instance the state information is determined with reference to haulage machine state change events 402a, haulage machine dipper report events 402b, haulage machine payload summary events 402c, and haulage machine cycle report events 402d. This information is processed by the system 202 using piecewise linear functions in order to estimate the operating hours of the haulage machine 102b as accurately as possible.

Based on these state objects 406 (and worksite information 404), system 202 determines a plurality of situations and generates situation objects 408 accordingly at stage 308. In the present example the relevant situation objects 408 comprise:
A fuel usage situation object 408a in respect of the particular haulage machine 102b.
In this instance the situation information is determined with reference to the fuel level state object 406a, the surface state object 406b, the operational state state object 406c, the position state object 406d, the payload state object 406e, and the operating hours state object 406h. The state information from these objects is processed using regression techniques to model fuel usage of the particular haulage machine 102b as a function of the explanatory variables.
A current location situation object 408b in respect of the particular haulage machine 102b.
In this instance the situation information is determined with reference to the position state object 406d and the path state object 406g. The state information from these objects is processed using geographic information system (GIS) techniques to determine the current load state of the particular haulage machine 102b. For example, the GIS can be used to find the nearest location on the planned path form the reported position of the haulage machine 102b using a ‘snap-to-path’ algorithm/technique.
A current load situation object 408c in respect of the particular haulage machine 102b.
In this instance the situation information is determined with reference to the operational state state object 406c.
A current destination situation object 408d in respect of the particular haulage machine 102b.
In this instance the situation information is determined with reference to machine assignment information 104b in respect of the particular haulage machine 102b. Once again this information may be used using GIS techniques.

Based on these situation objects 408, and worksite information 404, system 202 determines the impact of the situations and generates impact objects 410 accordingly at stage 310. In the present example the relevant impact objects 410 comprise:
A fuel impact object 410a in respect of the particular haulage machine 102b.
In this instance the impact information is determined with reference to the fuel usage situation object 408a, and is an estimate that the particular haulage machine 102b has sufficient fuel for only x more hours of operation.
An hours remaining impact object 410b in respect of the particular haulage machine 102b, indicating the number of hours of operation remaining in the machine's current assignment(s).
In this instance the impact information is determined with reference to the current location situation object 408b, the current load state situation object 408c, the current destination situation object 408d, and the production plan information 404d. The situation information from these objects is processed to determine that a new assignment is required for haulage machine 102b. This processing will typically be performed using a rules engine or by implementing fuzzy logic techniques.

Based on these impact objects 410, system 202 in generates operation instructions 412 at stage 312. In the present example the operation instructions 412 are based on the fuel impact object 410a and the operational hours remaining impact object 410b, and are refuelling instructions 412a to the particular haulage machine to attend a refuelling location 108 in the worksite before commencing another loading cycle (rather than commencing another loading cycle immediately).

If the confidence in the decision (based on the uncertainties from the upstream information used) is sufficiently high, system 202 will finales and automatically communicate the operation instructions to the haulage machine 102b. Alternatively, if the confidence is not sufficiently high the instructions/determined impact will be elevated to an operator for review and to make the final decision.

While the refuelling example has been described with reference to specific incident information (derived from various incident messages) and worksite information, a determination that refuelling is required may also be reached on processing a subset of this information and/or on alternative information. As a general proposition, however, the more information available for processing the more accurate (or more certain) the identified impacts will be.

### Datalogger Activation

Another example is where on processing incident messages and worksite data system 202 determines that a particular machine (e.g. a haulage machine 102b) can be operated in order to collect data. There may be a number of reasons why there may be a need/desire to collect data. For example, in order to monitor the surface condition of given roads/lanes (and whether a levelling/grading operation is needed) haulage machines 102b may be instructed to collect payload weight (e.g. strut) data as they traverse roads/lanes of interest. Such data can be analysed to look for spikes that exceed a given threshold which, in turn, can be interpreted to categorise the roughness of the road/lane.

With this example in mind, amongst the incident messages received by the system 202 (at stage 302) are incident messages reporting the haulage machine position, state, payload, and gear or speed information.

The system 202 processes these incident messages to generate corresponding event objects (at stage 304).

Based on the event objects, together with worksite information such as route information, system 202 determines and generates relevant state objects (at stage 306). In this particular example the state objects such as an operational state state object, a position state object, a payload state object, a path state object, and a surface state are used, which are/have been generated in a similar fashion to that described above with respect to the refuelling example.

Based on these state objects, system 202 determines (at stage 308) that the particular haulage machine 102b has been loaded with material and has entered a particular lane on a particular road on the worksite and generates situation objects accordingly.

Based on these situation objects, and additional worksite information available to the system 202, system 202 then determines the impact of the situations that have been determined and generates impact objects accordingly (at stage 310). In this case the impact is that is that the particular haulage machine 102b is suitable for the collection of payload weight data as it traverses the road/lane it is currently on.

Based on the impact objects, system 202 generates (at stage 312) operating instructions which instruct the haulage machine 102b to activate its payload load sensors in order to acquire payload data. These instructions are communicated to the haulage machine 102b (at stage 314) and, when received, are implemented by the processing system 203 of the haulage machine 102b (or, if the collection of data is not an automated operation, by an operator of the machine 102b who is provided with the instruction to activate data collection).

Once payload data has been collected it is used by the processing system 230 of the haulage machine 102b to generate a message communicating the sensed payload weight to the processing system 202 of the control centre 120, where it is received as an incident message (at stage 302) and processed accordingly (e.g. used to update surface information with respect to the road/lane).

### Generation of a New Machine Assignment

A further example is where on processing incident messages and worksite data system 202 determines that a particular machine (e.g. a haulage machine 102b) needs to be assigned further tasks.

As discussed above, amongst the incident messages received by the system 202 (at stage 302) are haulage machine operational state changes messages; haulage machine dipper report messages, haulage machine payload summary messages; haulage machine cycle report messages; haulage machine position report messages; loading machine dipper report messages; and loading machine dipper summary messages. Additionally, incident messages reporting machine health information are also received (for example reporting information on any critical faults, tyre temperature, tyre pressure, etc).

The system 202 processes these incident messages to generate event objects (at stage 304).

Based on these state objects, together with other worksite information (such as the current time and the time until the next shift change) system 202 determines (at stage 308) that the particular haulage machine 102b has entered a worksite dump location 106 with a particular weight of material of a particular type (e.g. with 200,000 kg of waste material) and generates situation objects accordingly.

Based on these situation objects, and additional worksite information available to the system 202, system 202 then determines the impact of the situations that have been determined and generates impact objects accordingly (at stage 310). In this case the impact is that is that once the particular haulage machine 102b has dumped its load at the dumping location 106 it will be unutilised, and as such needs to be issued with a new assignment. This determination is based on the above situation objects together with worksite information that the machine in question has no further current assignments.

Based on the determined impact, system 202 in generates (at stage 312) operating instructions which instruct the haulage machine 102b with a new assignment. These instructions are communicated to the haulage machine 102b (at stage 314) for implementation (though in the event of questions being raised regarding a new assignment—for example due to uncertainty information—a new assignment may also be flagged to a human operator for review).

### Worksite Development

A still further example is where on processing incident messages and worksite data system 202 determines that a location of the worksite 100 has reached a point where it can be further processed (for example by planning/creating roads and/or advancing a face).

Amongst the incident messages received by the system 202 (at stage 302) are incident messages reporting the positions of various machines; dipper report messages; payload summary messages; cycle report messages and other site survey messages (reporting information regarding the worksite).

The system 202 processes these incident messages to generate corresponding event objects (at stage 304).

Based on the information and uncertainty of the event objects, system 202 determines and generates state objects (at stage 306) in respect of the surface of the worksite at various locations. State objects may be generated with reference to additional worksite information, such as known discontinuities in the surface (which can be used so that high correlation is not assumed across such discontinuities).

Based on these state objects, system 202 determines (at stage 308, using processing techniques such as Kriging or inverse distance weighting) that a terrain model of the worksite has been updated/fused with elevation data in respect of a new location 114 at the worksite 100 and generates situation objects accordingly.

Based on these situation objects, and additional worksite information available to the system 202, system 202 then determines the impact of the situations that have been determined and generates impact objects accordingly (at stage 310). In this case the impact is that is that the new worksite location 114 is now level and that further operations in the location 114 can be planned (e.g. advancement of a face, the planning/creation of roads/lanes etc). This determination is based on the above situation objects together with worksite information that worksite location 114 has been set aside, for example as a new loading area or an extension of a current loading area.

Based on the determined impact, system 202 in generates (at stage 312) operating instructions for various worksite machines 102 to carry out the desired operations in respect of the new area—for example lane planning, surface levelling etc. These instructions are then communicated to relevant machines 102 (at stage 314) for implementation in due course.

It will be understood that the invention disclosed and defined in this specification extends to all alternative combinations of two or more of the individual features mentioned or evident from the text or drawings. All of these different combinations constitute various alternative aspects of the invention.

1. A computer-implemented method for determining a worksite machine requires refuelling, the method comprising:
operating a processing unit to access incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine;
operating said processing unit to access known worksite information selected from a group comprising: known machine parameter information with respect to the worksite machine; known assignment information with respect to the worksite machine; known route information with respect to one or more routes to be travelled by the worksite machine; and known production plan information;
operating said processing unit to process said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine;
operating said processing unit to process said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine;
operating said processing unit to process said situation information and said known worksite information to determine that the worksite machine has insufficient fuel to complete the tasks currently assigned to the worksite machine.

2. A computer-implemented method according to claim 1, wherein determining that the worksite machine has insufficient fuel to complete the tasks currently assigned comprises determining that the worksite machine has insufficient fuel to reach a destination defined by the destination situation information.

3. A computer-implemented method according to claim 2, wherein the destination situation information is derived from the known assignment information with respect to the worksite machine.

4. A computer-implemented method according to claim 1, wherein the method further comprises operating said processing unit to generate a refuelling instruction for transmission to said worksite machine.

5. A computer-implemented method according to claim 4, wherein the method further comprises transmitting the refuelling instruction to the worksite machine.

6. A computer-implemented method according to claim 1, wherein the incident message information further comprises information from a loading machine involved in loading material into the worksite machine.

7. A computer-implemented method according to claim 1, wherein said payload state information comprises payload weight state information and payload material state information in respect of the worksite machine.

8. A computer-implemented method according to claim 1, wherein the reported fuel information comprises fuel level information with respect to the worksite machine.

9. A computer-implemented method according to claim 1, wherein the estimated fuel level of the worksite machine is estimated using a Kalman filter process

10. A computer-implemented method according to claim 8, wherein inputs to the Kalman filter process comprise known machine parameter information, reported fuel information, and reported cycle information.

11. A computer-implemented method according to claim 1, wherein in order to generate the fuel usage situation information the processing unit processes the fuel level state information, the surface state information, the operational state state information, the position state information, the path state information, and the operating hours state information.

12. A computer-implemented method according to claim 1, wherein in order to generate the fuel usage situation information the processing unit processes the fuel level state information, the surface state information, the operational state state information, the position state information, the path state information, and the operating hours state information using regression techniques.

13. A non-transitory computer-readable medium comprising instructions which, when implemented by a computer processing system, cause the computer processing system to:
access incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine;
access known worksite information selected from a group comprising: known machine parameter information with respect to the worksite machine; known assignment information with respect to the worksite machine; known route information with respect to one or more routes to be travelled by the worksite machine; and known production plan information;
process said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine;
process said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine;
process said situation information and said known worksite information to determine that the worksite machine has insufficient fuel to complete the tasks currently assigned to the worksite machine.

14. A computer processing system comprising:
means for accessing incident message information, said incident message information selected from a group comprising: reported operational state information with respect to the worksite machine; reported payload information with respect to the worksite machine; reported cycle information with respect to the worksite machine; reported position information with respect to the worksite machine; and reported fuel information with respect to the worksite machine;
means for accessing known worksite information selected from a group comprising: known machine parameter information with respect to the worksite machine; known assignment information with respect to the worksite machine; known route information with respect to one or more routes to be travelled by the worksite machine; and known production plan information;
means for processing said incident message information and said known worksite information to generate state information, said state information selected from a group comprising: fuel level state information in respect of the worksite machine; surface state information in respect of the worksite; operational state state information in respect of the worksite machine; position state information in respect of the worksite machine; payload state information in respect of the worksite machine; path state information in respect of the worksite machine; and operating hours state information in respect of the worksite machine;
means for processing said state information and said known worksite information to generate situation information, said situation information selected from a group comprising: fuel usage situation information with respect to the worksite machine; current location situation information with respect to the worksite machine; current load state situation information with respect to the worksite machine; and destination situation information with respect to the worksite machine;
operating said processing unit to process said situation information and said known worksite information to determine that the worksite machine has insufficient fuel to complete the tasks currently assigned to the worksite machine.
